(19) United States
(12) Patent Application Publication
(10) Pub. No.: US 2022/0212284 A1
(43) Pub. Date: Jul. 7, 2022

(54) METHOD FOR PRODUCING MICROSTRUCTURES ON AN OPTICAL CRYSTAL

(71) Applicant: Q.ant GmbH, Stuttgart (DE)

(72) Inventors: Michael Foertsch, Ansbach (DE); Stefan Hengesbach, Stuttgart (DE); Louise Hoppe, Stuttgart (DE); Roman Priester, Stuttgart (DE); Marc Sailer, Villingen (DE); Marcel Schaefer, Burladingen (DE)

(21) Appl. No.: 17/704,058

(22) Filed: Mar. 25, 2022

Related U.S. Application Data
(63) Continuation of application No. PCT/EP2020/075716, filed on Sep. 15, 2020.

(30) Foreign Application Priority Data
Sep. 25, 2019 (DE) 10 2019 214 684.8

(51) Int. Cl. B23K 26/0622; B23K 26/40

(52) U.S. Cl. CPC B23K 26/0622; B23K 26/40

(57) ABSTRACT

A method for producing at least one optically usable microstructure, in particular at least one waveguide structure, on an optical crystal is provided. The method includes irradiating a pulsed laser beam onto a surface of the optical crystal, moving the pulsed laser beam and the optical crystal relative to one another along a feed direction in order to remove material of the optical crystal along at least one ablation path in order to form the optically usable microstructure. The pulsed laser beam is irradiated onto the surface of the optical crystal with pulse durations of less than 5 ps, preferably less than 850 fs, more preferably less than 500 fs, in particular less than 300 fs, and with a wavelength of less than 570 nm, preferably less than 380 nm.

### CROSS REFERENCE TO RELATED APPLICATIONS

This application is a continuation of International Application No. PCT/EP2020/075716 (WO 2021/058325 A1), filed on Sep. 15, 2020, and claims benefit to German Patent Application No. DE 10 2019 214 684.8, filed on Sep. 25, 2019. The aforementioned applications are hereby incorporated by reference herein.

### FIELD

Embodiments of the present invention relates to a method for producing at least one optically usable microstructure on an optical crystal.

### BACKGROUND

Crystalline substrates in the form of optical crystals, into which microstructures and/or waveguide structures are introduced, may be used for example in integrated optics and are an important component for modern (quantum) optical devices and switches. Conventional methods for producing such structures, such as are described below, are however restricted in their flexibility and the range of achievable designs. Furthermore, elaborate and expensive process chains, which make the development and establishment of competitive products more difficult, are needed for their implementation.

There are various approaches for the production of (waveguide) structures in optical crystals. One approach involves inscribing the waveguide into the optical crystal by refractive index modification, as is described for example in the article “High-repetition-rate femtosecond-laser micromachining of low-loss optical-lattice-like-waveguides in lithium niobate”, T. Piromjitpong et al., Proc. of SPIE Vol. 10684 (2018). A further approach involves producing microstructures by laser ablation.

Both approaches are described in the article “Optical waveguides in crystalline dielectric materials produced by femtosecond-laser micromachining”, Feng Chen et al., Laser Photonics Rev. 8, No. 2, 2014. There, inter alia, it is described that ridge waveguides may be produced by laser ablation by grooves, between which side walls of the ridge waveguides are formed, being introduced into the substrate. It is also described there that one disadvantage of the ridge waveguides produced in this way is that rough side walls, which reduce the quality of the ridge waveguide and increase its losses, are formed during the laser ablation with femtosecond laser pulses.

The production of waveguide structures in lithium niobate (LiNbO₃) crystals by laser ablation is described, for example, in the article “All-laser-micromachining of ridge waveguides in LiNbO₃ crystal for mid-infrared band applications”, L. Li et al., Scientific Reports 7:7034 (2017). There, a ridge waveguide is produced in a lithium niobate crystal entirely by microfabrication by means of a femtosecond laser. The ridge waveguide consists of side walls removed by laser ablation in the form of grooves with V-shaped flanks and a laser-scribed bottom. A Ti:sapphire solid-state laser with a wavelength of 796 nm is used as the laser source.

In the article “Ablation of Lithium Niobate with Pico- and Nanosecond Lasers”, F. Haehnel, LaserTechnikJournal, Vol. 9, Issue 3, June 2012, pages 32-35, a comparison between picosecond and nanosecond laser sources for the ablation of lithium niobate is described. The nanosecond laser source is a UV excimer laser with a wavelength of 193 nm or 245 nm. For the picosecond laser source, a wavelength of 355 nm (3rd harmonic of a fundamental wavelength of 1064 nm) with pulse durations of less than 12 ps and repetition rates of between 200 kHz and 1 MHz was used to carry out the comparison. During the comparison, it was found that, despite a lower average power, the removal rate of the picosecond laser source was much greater than in the case of the excimer laser source, and that the crack formation was reduced. The studies carried out in the article were conducted on membranes, i.e. optical components were not produced or characterized.

EP 0 803 747 A2 describes a method for producing a substrate, which is provided with an optical waveguide in the form of a ridge waveguide. The ridge waveguide is produced by laser ablation, for example by using an excimer laser with wavelengths of between 150 nm and 300 nm and pulse durations in the range of nanoseconds. To this end, the laser beam may be aligned with a surface of the substrate and moved, or scanned, over the substrate. The optical axis of the laser beam is in this case aligned vertically with respect to the surface of the substrate.

The ridge waveguide is intended to have a cross-sectional profile that is as rectangular as possible, in order to avoid light losses.

US 2004/0252730 A1 describes the processing of lithium niobate by laser ablation. It is proposed to irradiate the surface of a substrate with a pulsed laser beam in order to remove material. The laser is intended to have a wavelength of between 310 nm and 370 nm. The pulse duration of the laser pulses may be about 40 ns and the repetition rate may be about 1000 kHz. The laser beam and the substrate may be displaced relative to one another in order to produce a trench with a desired geometry in the lithium niobate.

### SUMMARY

Embodiments of the present invention provide a method for producing at least one optically usable microstructure, in particular at least one waveguide structure, on an optical crystal. The method includes irradiating a pulsed laser beam onto a surface of the optical crystal, moving the pulsed laser beam and the optical crystal relative to one another along a feed direction in order to remove material of the optical crystal along at least one ablation path in order to form the optically usable microstructure. In some embodiments, the pulsed laser beam is irradiated onto the surface of the optical crystal with pulse durations of less than 5 ps, preferably less than 850 fs, more preferably less than 500 fs, in particular less than 300 fs, and with a wavelength of less than 570 nm, preferably less than 380 nm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an apparatus for producing waveguide structures on an optical crystal by removing material in order to form a plurality of trenches extending parallel by using a pulsed laser beam according to some embodiments;

FIG. 2 shows two of the trenches of FIG. 1 in cross-sectional view during the production by laser ablation according to some embodiments;

FIG. 3 shows a representation of an apparatus similar to FIG. 1 with a laser processing head for aligning the laser beam at an angle with respect to the surface of the optical crystal according to some embodiments;

FIG. 4 shows a representation of an apparatus similar to FIG. 1 with a tiltable platform, on which the optical crystal is mounted according to some embodiments;

FIG. 5 shows a representation of the laser ablation of material during the production of a ridge waveguide with approximately vertical side walls according to some embodiments;

FIG. 6 shows a representation of a laser beam having an elliptical beam profile, which is irradiated at an angle with respect to the normal direction onto the surface of the optical crystal according to some embodiments; and

FIG. 7 shows a representation of an optical coupler having two ridge waveguides, which have been produced by laser ablation according to some embodiments.

### DETAILED DESCRIPTION

Embodiments of the present invention provide a method for producing at least one optically usable microstructure, in particular at least one waveguide structure, on an (in particular nonlinear) optical crystal. The method includes irradiating a pulsed laser beam onto a surface of the optical crystal, and moving the pulsed laser beam and the optical crystal relative to one another along a feed direction in order to remove material of the optical crystal along at least one ablation path in order to form the optically usable microstructure, in particular the waveguide structure. The method can improve the quality of the microstructure(s) produced.

In some embodiments, the pulsed laser beam is irradiated onto the surface of the optical crystal with pulse durations of less than 2.5 ps, preferably less than 850 fs, more preferably less than 500 fs, in particular less than 300 fs, and with a wavelength of less than 570 nm, preferably less than 380 nm.

The inventors have found that the quality of the (optically usable) microstructures produced during the laser ablation, particularly in the form of waveguide structures, can be significantly increased if the pulse duration is of the order of fs and a wavelength in the green wavelength range, i.e. between 490 nm and 570 nm, or less, for example in the UV wavelength range with wavelengths of less than 380 nm (and generally more than 330 nm), is used. Although conventional methods can produce waveguide structures, for example in the form of ridge waveguides, by laser ablation, this is only with an insufficient quality, particularly in respect of the roughness of the side walls of the ridge waveguides (cf. the article cited above by Feng Chen et al.). The result of this is that the waveguide structures can be used only for guiding light in the NIR wavelength range, but not for guiding light in the VIS wavelength range.

With the aid of the method described herein according to some embodiments, the roughness of the side walls of the waveguides can be reduced. In particular, waveguides with steep side walls may also be produced. In this way, it is possible to produce waveguide structures for guiding light in the VIS and NIR wavelength ranges, and to generate and guide frequency-converted light by nonlinear optical processes in these frequency ranges. Examples thereof are parametric down-conversion, sum frequency generation or the generation of higher harmonics. Besides (light) waveguides, other microstructures for the production of integrated optics may also be produced with the aid of the method described herein according to some embodiments.

When irradiating the laser beam onto the surface of the optical crystal, a beam axis of the laser beam may be aligned perpendicularly to the generally planar surface of the optical crystal. In this case, a translational movement of a bearing device, for example in the form of a translation platform, on which the generally plate-shaped crystal is mounted during the production of the microstructures, can be carried out in a horizontal plane (parallel to the surface of the optical crystal). The laser processing head, from which the pulsed laser beam emerges and is aligned with the surface of the optical crystal, may in this case be arranged statically, although it is also possible for the laser processing head to be moved over the surface of the optical crystal. The laser beam emerging from the laser processing head can be focused onto the surface of the optical crystal.

In one variant of the method, a beam axis of the laser beam is tilted at an angle relative to a normal direction of the surface of the optical crystal during the movement of the laser beam and of the optical crystal relative to one another, the angle preferably lying in a plane perpendicular to the feed direction. In this variant, the laser beam strikes the surface of the optical crystal not perpendicularly but at an angle not equal to 0°. The feed direction of the ablation path, along which the material is removed, generally extends parallel to the processing plane, or the surface of the substrate. The angle at which the laser beam is tilted with respect to the normal direction of the surface can lie in a plane that extends perpendicularly to the (optionally locally varying) feed direction. The effect which may be achieved by the alignment at the angle is that one of the two side walls, or side edges, of the ablation path extends more steeply and the other side wall of the ablation path which is produced in the optical crystal extends more shallowly than would be the case with perpendicular incidence of the laser beam on the surface.

In a further variant, the angle 0 lies between 2° and 60°, preferably between 10° and 45°, particularly preferably between 15° and 30°. It has been found to be favourable to select the angle at which the laser beam is aligned with respect to the normal direction in the specified interval, in order to achieve the effect that one of the two side walls of the ablation path is aligned as steeply as possible, i.e. as parallel as possible to the normal direction of the surface. For the case in which the side wall of the ablation path, or of the trench in the optical crystal, forms the side wall of a waveguide, an alignment that is as steep as possible is favourable, since in this way light losses due to light guided in the waveguide emerging through the side wall can be kept small. As a result of steep side walls and an adjustable aspect ratio of height to width, rotationally symmetrical eigenmodes may be guided in the waveguide. The mode overlap with light guide fibres may thereby be maximized, which ensures a high efficiency that is advantageous for (quantum) optical constructions.

For the case in which rectilinear ablation paths are intended to be produced, the feed direction is constant during the relative movement of the laser beam and the optical crystal. The feed direction may vary locally when curvilinear ablation paths or microstructures are intended to be produced. In both cases, the angle at which the laser beam is tilted relative to a normal direction of the surface of the optical crystal can be adjusted independently of the selected—optionally locally varying—feed direction. In the case of a conventional static laser scanner for processing a statically arranged workpiece, this is usually not the case since the laser beam is aligned at a predetermined scan angle at a respective position on the surface of the workpiece.

In one variant, an angle at which the laser beam emerges from a laser processing head is set for the tilting of the beam axis of the laser beam, and the movement of the laser beam and of the optical crystal relative to one another comprises a displacement of the laser processing head and of the optical crystal relative to one another.

As described above, for position-independent adjustment of the angle of the beam axis of the laser beam with respect to the normal direction of the surface of the optical crystal, it is usually not sufficient merely for a scanning movement of the laser beam to be carried out. In addition to the alignment of the laser beam at an adjustable angle when emerging from the laser processing head, a translational movement, or a relative displacement between the optical crystal and the laser processing head, can be carried out. The laser processing head, which allows the alignment of the laser beam at a (scan angle), may be a trepanning system, or a conventional scanner device which comprises two tiltable scanner mirrors, a scanner mirror generally tiltable about two rotation axes, or a combination of a polygon scanner and a tiltable scanner mirror.

In a further variant, an angle at which the laser beam emerges from a laser processing head is set for the tilting of the beam axis of the laser beam, and the movement of the laser beam and of the optical crystal relative to one another is carried out by means of a scanner device, the laser beam being focused in or at the laser processing head, preferably by means of telecentric flat field optics, onto the optical crystal.

For the production of linear waveguide structures in particular, it has been found favourable to carry out the movement along the feed direction by means of a scanner, in particular by using a polygon scanner. A combination of a polygon scanner for deflecting the laser beam in the feed direction, for example in the Y direction, and a galvanometer scanner for deflecting the laser beam perpendicularly to the feed direction, for example in the X direction, is also possible. The laser processing head and the surface of the optical crystal may in this case be aligned with one another at an (advance) angle, which may be adapted or adjusted mechanically or electrically by an adjustment device, for example by a goniometer. The use of telecentric flat field optics for focusing the laser beam onto the optical crystal is advantageous so that no further angle other than this advance angle in the XZ plane occurs during the processing in the YZ plane between the surface normal of the optical crystal and the optical axis of the laser beam.

In a further variant, an angle at which a platform, on which the optical crystal is mounted, is aligned relative to a horizontal plane is set for the tilting of the beam axis of the laser beam. The platform on which the optical crystal is mounted is preferably a rotation/translation platform, which allows rotation about at least one rotation axis. In principle, the rotation/translation platform may be configured for rotation about a plurality of rotation axes in order to orientate it freely in space, for example in the manner of a hexapod, goniometer pair or the like.

In both variants described above, it is possible in principle to carry out free processing of an optical crystal in all spatial directions, which opens up new types of design and product possibilities.

In a further variant, the laser beam has an elliptical beam profile, the aspect ratio (length to width) of which is selected in such a way that the laser beam aligned at the angle with respect to the normal direction strikes the surface with a circular beam profile. It has been found to be favourable for the ablation process if the laser beam which is aligned with the surface of the optical crystal has a round or rotationally symmetrical, preferably Gaussian beam profile. If a laser beam with a circular beam profile is irradiated at an angle with respect to the surface of the optical crystal, it strikes the surface with an elliptical, rotationally asymmetrical beam profile (spot). In order nevertheless to produce a circular beam profile on the surface, in this variant a laser beam with an elliptical beam profile is irradiated onto the surface. Such an elliptical beam profile may be produced by means of beam shaping optics, for example with the aid of a cylindrical lens or a lens telescope or the like. In particular, such beam shaping optics may be configured to modify the aspect ratio of the elliptical beam profile.

The following applies for the aspect ratio which produces a circular beam profile on the surface:

B/L=cos(θ),

where L denotes the length and B the width of the elliptical beam profile and θ denotes the angle with respect to the normal direction of the surface. The elliptical beam profile is in this case aligned in such a way that the short side (i.e. the width B) lies in the plane of the angle at which the beam axis of the laser beam is aligned with respect to the normal direction of the surface.

It may possibly be favourable for the beam profile of the laser beam to deviate deliberately from a circular or rotationally symmetrical geometry, for example in order to produce a line focus on the surface of the optical crystal, as is described in WO 2018/019374 A1,which is incorporated in its entirety into the content of this application by reference. Such a line focus may, for example, be produced by using asymmetric modes. The roughness of the microstructures produced may likewise be improved when using a line focus.

In a further variant, the laser beam and the optical crystal are moved relative to one another several times along laterally offset ablation paths in order to form a trench in the optical crystal. In order to form the microstructures, or the waveguides, a plurality of ablation paths are generally offset in parallel systematically with respect to one another. The ablation paths either extend in a straight line or form curved structures in the XY plane on the surface of the crystal, or of the wafer. In this way, for example, it is possible to produce meander structures or tapers. A plurality of ablation paths can be superimposed laterally and optionally vertically, i.e. in the thickness direction of the optical crystal. In this way, trenches with a predetermined width and depth may be produced in the optical crystal. Depending on the desired geometry, the laser parameters may also be adapted according to the respective ablation path. As described above, it is advantageous to use a polygon scanner, which deflects the laser pulses in the feed direction along the direction of the trenches, in order to form the trenches, or produce the ablation paths.

In a further variant, a first trench and a second trench are formed in the optical crystal, neighbouring side walls of the first trench and of the second trench having a predetermined distance from one another and the side walls forming a ridge waveguide. By the two trenches, which extend at a predetermined (generally constant) distance from one another, lateral confinement which makes it possible to guide light in the ridge waveguide, or in the waveguide structure, is produced. In the simplest case, the trenches may consist of a single ablation path, which extends along the feed direction or which describes a straight line or a curve with varying radii. In general, however, material is removed along a plurality of ablation paths in order to form the trenches (see above). It has been found to be favourable for the geometry in which the ablation paths are executed in order to form the first and second trenches to be mirror-symmetrical in relation to the side walls of the ridge waveguide, i.e. ablation is carried out either towards or away from the respective side wall of the ridge waveguide during the formation of the two trenches.

In one refinement, during the formation of the first and second trenches, at least along ablation paths which extend next to a respective side wall of the ridge waveguide, the beam axis of the laser beam is tilted at an angle relative to a normal direction of the surface of the substrate, which angle is inclined away from the respective side wall of the ridge waveguide. Ablation paths extending next to the side wall are intended to mean at most ten ablation paths, which are arranged closest next to the side wall of the ridge waveguide. The effect which may be achieved by the tilting of the beam axis of the laser beam away from the side wall of the ridge waveguide is that the side wall of the ridge waveguide extends as steeply as possible, i.e. as parallel as possible to the normal direction of the surface of the optical crystal.

The angle at which the beam axis of the laser beam is aligned with respect to the normal direction may be constant for all ablation paths of a trench. In this case, a steep side wall that faces towards the waveguide is produced in each of the two trenches. It is, however, also possible to vary the angle, at which the laser beam is aligned with respect to the normal direction, along the width of a respective trench. In particular, the angle may be modified in such a way that, along ablation paths that extend next to a trench side wall facing away from the ridge waveguide, the angle with respect to the normal direction is inclined away from the side wall facing away from the ridge waveguide. In this way, it is possible to produce a trench that has steep side walls, or steep flanks, on both sides. This may be favourable in order to form further waveguide structures, or ridge waveguides. In particular, in this case the first and second trenches may have an identical cross section.

In one refinement of this variant, the laser beam is focused onto a focal plane, which corresponds to the surface of the optical crystal, during the formation of a respective trench. Readjustment of the focal plane after the execution of each ablation path onto the surface of the previously generated trench, i.e. stepwise lowering of the focal plane below the surface of the optical crystal, is also possible.

In a further refinement, the laser beam and the optical crystal are moved several times along the same ablation path relative to one another on a side wall of the trench, which forms a side wall of the ridge waveguide. In this way, smoothing of the edge, or of the side wall, is achieved. During the first execution of the ablation path, a set of laser parameters which is optimized for the surface abrasion may be adjusted. During the second and each further execution of the ablation path, a different set of laser parameters, which is optimized for the smoothing, may be adjusted. Smoothing of the side wall, however, may not be necessary and may be omitted in some embodiments.

In a further variant, the optical crystal is selected from the group consisting of: lithium niobate (LiNbO₃), lithium tantalate LiTa, KTP (potassium titanyl phosphate). As described above, in this (and other) optical crystals both the generation and the waveguiding of frequency-converted light may be carried out by nonlinear optical processes. By the method described above, in such an optical crystal it is possible to produce waveguides whose side walls have a low roughness of Rₐ<40 nm. The low roughness and the production of (approximately) perpendicular side walls of the waveguides also makes it possible to guide light in the visible wavelength range.

In a further variant, the optical crystal has a refractive index structure for planar waveguiding, and in particular is configured as an LNOI (lithium niobate-on-insulator) or PELN (proton-exchanged lithium niobate). The method described above may, in particular, be used on preprocessed optical crystals that have a refractive index structure for planar waveguiding, in order to produce vertical confinement of the light guided in the waveguide. When using such optical crystals, for example in the case of LNOI, it is necessary to take care that the depth of the ablated trenches corresponds (approximately) to the height or thickness of the guiding layer, since otherwise losses of light occur. In principle, it is also possible to produce vertical confinement in an optical crystal that does not have a refractive index variation, by refractive index structures being introduced into the optical crystal by means of the pulsed laser beam.

In a further variant, the pulsed laser beam is produced by a solid-state laser. Solid-state lasers make it possible to produce laser pulses with very short pulse durations in the fs range. By frequency doubling, or frequency multiplication, solid-state lasers can generate wavelengths in the green wavelength range, for example at 515 nm, or in the UV wavelength range, for example at 343 nm. As an alternative, it is optionally possible for the pulsed laser beam to be generated by an excimer laser.

In a further variant, the method comprises: supplying a fluid to the surface of the optical crystal in order to take away removed material. By the improved taking away of the ablated material, it is possible to achieve an improved roughness of the side walls of the trenches, or of the waveguide structures. The fluid may, for example, be a generally inert process gas which is preferably fed over the surface of the optical crystal counter to the feed direction. As an alternative, the supplied fluid may be a liquid. In principle, it is possible to introduce a liquid between the laser processing head from which the laser beam emerges and the surface of the optical crystal, in order to reduce the spot size of the laser beam.

Repetition rates of between about 600 kHz and 1000 kHz can be used as laser parameters for the ablation described above. It is possible for the repetition rate to vary, i.e. for short, high repetition rates followed by long pulse pauses to be used for the ablation (burst operation). Feed speeds can be between about 500 and 1500 mm/s, and therefore higher than in conventional production methods. The average laser power is of the order of between about 0.5 and 2 watts, and the energy input per laser pulse is of the order of between 0.5 and 5 μJ. By avoiding masks for the production of the waveguide structures, a cost-efficient process chain may furthermore be produced. Greater flexibility compared with conventional production methods is also achieved, so that waveguides with relatively complex geometries may also be produced in the manner described above. The waveguide structures, or the integrated optics, may for example be optical couplers, optical switches or logic components, etc.

In a further variant, the method comprises: moving the preferably pulsed laser beam used for removing material and the optical crystal relative to one another, particularly in the region of the waveguide structure, in order to produce a periodic poling structure with period lengths of less than 50 μm in the optical crystal. In this variant, the step of the periodic poling of the material of the optical crystal is integrated directly into the process chain by the laser beam used for the ablation of the material additionally travelling over the optical crystal one or more times in order to produce a poling structure. In conventional methods for the introduction of periodic poling, on the other hand, it is necessary to apply an electric field by means of dipoles.

In one variant, the method comprises: exposing the optical crystal through a phase mask with the preferably pulsed laser beam used for removing material, particularly in the region of the waveguide structure, in order to produce a periodic poling structure with period lengths of less than 10 μm in the optical crystal. In this case as well, the laser beam used for the ablation is used for the introduction of periodic poling into the material of the optical crystal. Since the poling structure is defined by the phase mask in this variant, the periodic poling may be produced with a smaller period length than is the case in the variant described above.

Further advantages of the invention may be found in the description and the drawing. Likewise, the features mentioned above and those referred to below may be used independently, or several of them may be used in any desired combinations. The embodiments shown and described are not to be interpreted as an exhaustive list, but rather have an exemplary nature for description of the invention.

In the following description of the drawings, identical references are used for components which are the same or functionally equivalent.

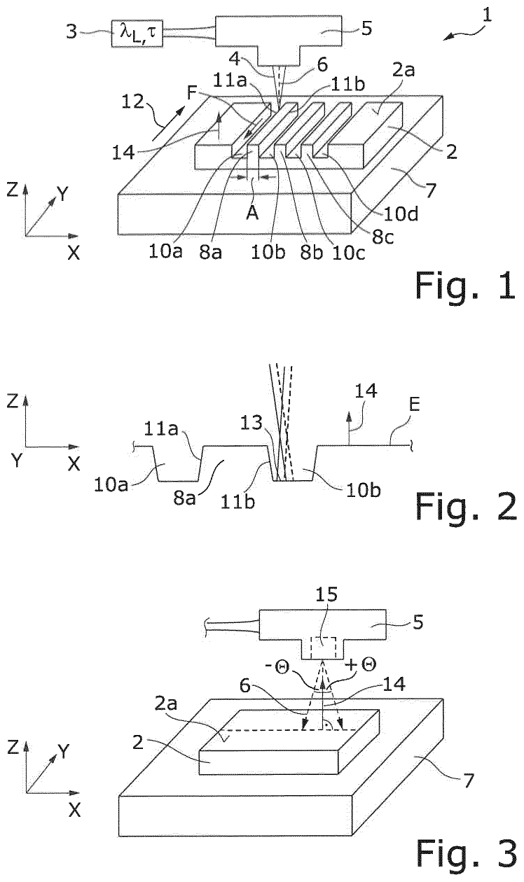

FIG. 1 shows an exemplary structure of an apparatus 1 for producing microstructures on a substrate in the form of an optical crystal 2, for example in the form of a wafer, according to some embodiments. The apparatus 1 comprises a laser source 3 for generating a laser beam 4, which is conveyed by means of a beam guiding, indicated in FIG. 1, to a laser processing head 5. The laser processing head 5 directs the laser beam 4 onto the optical crystal 2, and specifically onto a surface 2a of the optical crystal 2, which in the example shown forms the planar upper side of the optical crystal 2.

In the example shown in FIG. 1, the laser source 3 is a solid-state laser which is configured to generate the laser beam 4 at a wavelength of between 330 nm and 570 nm (or 550 nm). The laser source 3 may, for example, be configured to generate the laser beam 4 at a wavelength of 343 nm, i.e. in the UV wavelength range, or 532 nm, i.e. in the green wavelength range. The solid-state medium of the laser source 3 may, for example, be Yb:YAG. The laser source 3 is configured to generate a pulsed laser beam 4 with pulse durations in the ps or fs range. For the method described below, pulse durations τ of less than 5 ps, for example less than 850 fs, in particular less than 500 fs, optionally less than 300 fs, have been found advantageous.

The laser source 3 which is configured for generating a pulsed laser beam 4 having such pulse durations may, for example, be a disc, slab or fibre laser. As an alternative, an excimer laser may be used, even though this is generally not suitable for generating pulse durations in the fs range.

The pulsed laser beam 4 is irradiated onto the surface 2a of the optical crystal 2 facing towards the laser processing head 5. As may be seen in FIG. 1, a beam axis 6 of the laser beam 4 is aligned perpendicularly with respect to the surface 2a of the optical crystal 2, which in the example shown forms the processing plane. The optical crystal 2 is mounted on a translation platform 7, which can be displaced with the aid of actuators (not graphically represented) in the X direction and, independently thereof, in the Y direction and in the Z direction of an XYZ coordinate system. The translation platform 7 may also be rotated about a rotation axis aligned in the Z direction.

As may be seen in FIG. 1, during the material-removing processing of the optical crystal 2 by means of the pulsed laser beam 4, microstructures in the form of three parallel-aligned waveguide structures extending in the Y direction are formed in the form of ridge waveguides 8a-c, which have a substantially rectangular cross section. To this end, four parallel-aligned trenches 10a-d, likewise extending in the Y direction, are introduced into the optical crystal 2 by means of the pulsed laser beam 4. The three ridge waveguides 8a-c are respectively arranged between two neighbouring trenches 10a-d.

As is represented in FIG. 1 by way of example for the first ridge waveguide 8a, the first trench 10a and the neighbouring second trench 10b have a predetermined constant distance A from one another, which in the example shown is measured at the bottom of the two trenches 10a,b and which, for example, may be about 15 μm. A right side wall 11a of the first trench 10a and a neighbouring left side wall 11b, facing towards the first trench 10a, of the second trench 10b form the side walls 11a, 11b of the first ridge waveguide 8a. The same applies for the trenches 10b-d and the second and third ridge waveguides 8b, 8c.

In order to produce the trenches 10a-d, and in this way to form the ridge waveguides 8a-c, the pulsed laser beam 4 and the optical crystal 2 are moved relative to one another. In the example shown in FIG. 1, the laser processing head 5 is arranged statically. In order to generate a movement of the pulsed laser beam 4 and of the optical crystal 2 relative to one another, the translation platform 7 is therefore moved along a feed direction 12, which corresponds to the Y direction of the XYZ coordinate system. The pulsed laser beam 4 is in this case moved several times along ablation paths 13 offset laterally (i.e. in the X direction) in order to produce a respective trench 10a-d, as is represented by way of example in FIG. 2 for the second trench 10b. It is to be understood that the movement of the optical crystal 2 along one respective ablation path 13 may take place in the positive Y direction, and the neighbouring ablation path 13 may be executed in the negative Y direction, in order to accelerate the ablation process.

As is indicated in FIG. 1 by an arrow, a fluid F, which in the example shown forms a gas flow of an inert gas, for example nitrogen, may be supplied to the surface 2a of the optical crystal 2. The gas flow, or the fluid F, is aligned counter to the feed direction 12 in FIG. 1, in order to take away removed or ablated material. The gas flow may, for example, be produced with the aid of a nozzle fitted to the laser processing head 5.

In the example shown in FIG. 1, about seventy ablation paths 13 are in each case offset laterally in the X direction in order to form a respective trench 10a-d, of which two neighbouring ablation paths 13 are shown in FIG. 2. The lateral offset between two neighbouring ablation paths 13 is about 3 μm in the example shown. The pulsed laser beam 4 is focused by means of a focusing device (not graphically represented) arranged in the laser processing head 5, for example in the form of a focusing lens, onto the optical crystal 2, and specifically in a focal plane E, which in the example shown in FIG. 2 coincides approximately with the surface 2a of the optical crystal 2. In the example shown in FIG. 2, the (minimum) focal diameter of the laser beam 4 is about 17 μm.

The parameters of the pulsed laser beam 4 are optimized for surface abrasion of the material of the optical crystal 2. It is, however, to be understood that it may be sufficient for the laser beam 4 to be moved only along a single ablation path 13 in the feed direction in order to form a trench 10a-d. In order to increase the depth of a respective trench 10a-d, the above-described process of removing material along a plurality of laterally offset ablation paths 13 may optionally be repeated several times, so that the ablation paths 13 lie vertically above one another. In this way, a respective trench 10a-d with a desired width and depth may be produced.

In order to smooth the side wall 11b shown in FIG. 2 of the second trench 10b, which forms the (right) side wall of the first ridge waveguide 8a, the optical crystal 2 and the laser beam 4 are moved with respect to one another several times, for example at least five times, along the same ablation path 13 in the feed direction 12. In this case, the laser parameters, for example the pulse duration τ, the feed speed, the (average power), etc., during the first execution of the ablation path 13 may differ from the laser parameters which are used during the second, third, . . . , executions of the ablation path 13: the laser parameters during the first execution of the ablation path 13 are in this case optimized for the surface abrasion, while the laser parameters during the second, third, . . . , executions of the ablation path 13 are optimized for smoothing the side wall 11b of the ridge waveguide 8a.

As may be seen in FIG. 2, the side walls 11a,b of the ridge waveguide 8a which has been produced in the manner described above do not extend exactly perpendicularly to the surface 2a of the optical crystal 2, but are inclined slightly with respect to the vertical, or the normal direction 14, of the surface 2a of the optical crystal 2.

In order to produce ridge waveguides 8a-c with side faces 11a,b that are as steep as possible, as are represented in FIG. 1, it has been found favourable to tilt the beam axis 6 of the laser beam 4 at an angle θ relative to the normal direction 14 of the surface 2a of the optical crystal 2, and specifically transversely to the feed direction 12 in the example shown, i.e. in the XZ plane, during the ablation, or during the movement of the pulsed laser beam 4 and of the optical crystal 2 relative to one another.

In order to achieve this, the laser processing head 5 may comprise a scanner device 15, which makes it possible to adjust a (scan) angle θ at which the laser beam 4 emerges from the laser processing head 5, as is represented by way of example in FIG. 3. The scanner device 15 (trepanning system) generally comprises two scanner mirrors tiltable independently of one another, a scanner mirror rotatable about two rotation axes, or a combination of a polygon scanner and a rotatable mirror scanner, or scanner mirror, in order not only to be able to adjust the angle θ in the XZ plane, as is represented in FIG. 3, but to be able to orientate, or align, the laser beam 6 in any desired way when it emerges from the laser processing head 5. The scanner device 15 may, for example, comprise a polygon scanner in order to deflect the laser beam 4 along the feed direction 12 in the YZ plane in order to form the trenches 10a-d. In this case, it is favourable for a focusing device in the form of telecentric flat field optics to be arranged in the laser processing head 5, in order to focus the laser beam 4 onto the optical crystal 2 after the deflection.

Owing to the possibility of displacing the optical crystal 2 in the X direction and the Y direction with the aid of the translation platform 7, the scan angle θ may be adjusted for each orientation of the feed direction 12 in the XY plane, independently of the place at which the laser beam 4 strikes the surface 2a of the optical crystal 2. This is favourable since the scan angle θ at which the beam axis 6 of the laser beam 4 is aligned relative to the normal direction 14 of the surface 2a of the optical crystal 2 is generally intended to be aligned in a plane perpendicular to the feed direction 12, as described below. FIG. 3 shows by way of example two scan angles −θ0, +θ, at which the beam axis 6 of the laser beam 4 may be aligned in the XZ plane relative to the normal direction 14.

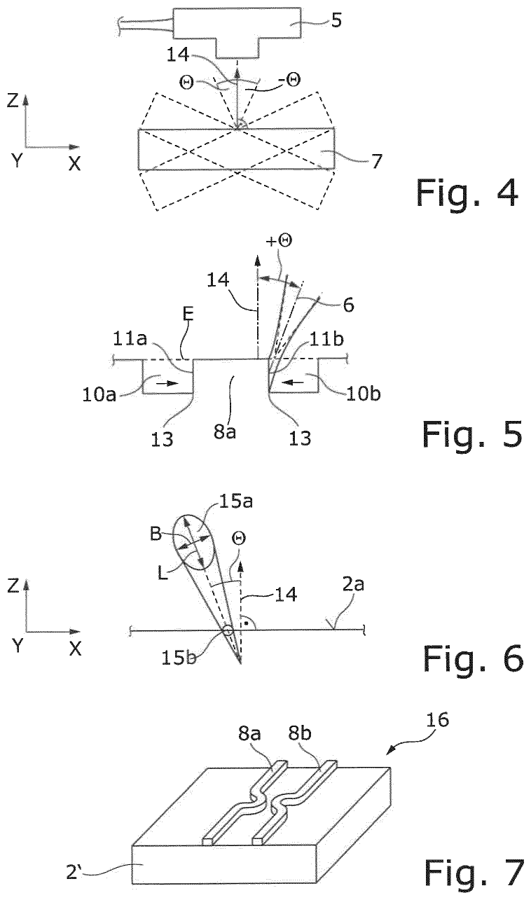

FIG. 4 shows a further possibility for aligning the laser beam 4 at an angle θ with respect to the normal direction 14 of the optical crystal 2: in this example, the platform 7 on which the optical crystal 2 is mounted is a translation/rotation platform, which can be tilted at an angle θ with respect to a horizontal plane (XY plane). The translation/rotation platform 7 may be tilted about more than one rotation axis. In this way, it is possible to modify the plane in which the angle θ lies as a function of the respectively selected feed direction 12. In particular, the translation/rotation platform 7 may be a hexapod, a goniometer or the like.

It is to be understood that the two possibilities, described in FIG. 3 and FIG. 4, for adjusting the angle θ at which the beam axis 6 of the laser beam 4 is aligned with respect to the normal direction 14 may optionally be combined.

In order to produce the waveguides 8a-c shown in FIG. 1 with side faces 11a,b that are as steep as possible, the ablation of material as described in connection with FIG. 1 may be carried out in order to produce the trenches 10a-d. In contrast to the method described above, the beam axis 6 of the laser beam 4 is tilted at an angle −θ, +θ, with respect to the normal direction 14 of the surface 2a of the optical crystal 2, which is inclined away from the respective side wall 11a,b during the formation of a respective trench 10a-d, at least along ablation paths 13 that extend next to a side wall 11a,b of a respective ridge waveguide 8a, 8b, . . . , as is represented by way of example in FIG. 5 for the first ridge waveguide 8a.

In order to produce side walls 11a,b that are as steep as possible, aligned perpendicularly to the surface 2a of the optical crystal 2, it has been found favourable for the angle θ to be between 2° and 60°, preferably between 10° and 45°, in particular between 15° and 30°. As in the example shown in FIG. 2, the laser beam 4 is also focused in the example shown in FIG. 5 onto a focal plane E that coincides with the surface 2a of the optical crystal 2. The smoothing of the respective side walls 11a,b may be carried out in the manner described above in connection with FIG. 1. Readjustment of the focal plane E after the execution of each ablation path 13 onto the surface of the previously generated trench, or of the previously removed material, i.e. stepwise lowering of the focal plane below the surface 2a of the optical crystal 2, is also possible.

The angle θ at which the laser beam 4 is aligned with respect to the normal direction 14 may be the same, i.e. constant, for all ablation paths 13 of a respective trench 10a,b, although it is also possible for the angle θ to vary in the lateral direction. For example, the angle θ for ablation paths 13 in the vicinity of the side walls of the respective trench 10a,b which face away from the ridge waveguide 8a may be aligned opposite to the representation of FIG. 5, in order to produce side walls that are as steep as possible there as well.

As is indicated in FIG. 5 by arrows, the ablation paths 13 in the two trenches 10a, b are produced in an order which runs from the side facing away from the side wall 11a,b of the ridge waveguide 8a to the side of the respective trench 10a,b facing towards the side wall 11a,b of the ridge waveguide 8a. Such an ablation order, as well as an ablation order in which ablation is carried out in both trenches 10a,b starting from the two side walls 11a,b of the ridge waveguide 8a towards the opposite side of the trench 10a,b, has also been found to be advantageous.

If the laser beam 4 has a circular beam profile and if it is aligned at an angle θ with respect to the normal direction 14 of the surface 2a of the optical crystal 2, it strikes the surface 2a of the optical crystal 2 with an elliptical beam profile. For the ablation, however, it has been found favourable for the laser beam 4 to strike the surface 2a of the optical crystal 2 with a beam profile that is as rotationally symmetrical as possible, for example a Gaussian beam profile. In order to ensure that the laser beam 4 strikes the surface 2a with a circular beam profile 15b even with the alignment at an angle θ with respect to the normal direction 14, as represented in FIG. 6, it is favourable for the laser beam 4 to be generated with an elliptical beam profile 15a, the aspect ratio of which, i.e. the ratio of length L to width B, is selected in such a way that the laser beam 4 strikes the surface 2a with a circular beam profile 15b.

For the aspect ratio of the elliptical beam profile 15a, which produces a circular beam profile 15b on the surface 2a, the following applies:

B/L=cos (θ).

The short side, i.e. the width B of the elliptical beam profile 15a, in this case lies in the XZ plane, in which the angle θ is also located.

FIG. 7 shows integrated optics in the form of an optical coupler 16, which comprises two ridge waveguides 8a,b that have been produced in the manner described above by laser ablation, by removing the surrounding material so that, other than the two ridge waveguides 8a,b, only an insulator layer 2′ remains. The optical crystal 2, from which the ridge waveguides 8a, b have been formed, is in the example shown LNOI, i.e. LiNbO₃ which is applied on the insulator layer 2′. Vertical confinement of the ridge waveguides 8a, b is produced by the insulator layer 2′. As may be seen in FIG. 7, the ridge waveguides 8a, b are not rectilinear but have a curved section in order to achieve the optical coupling. Such and other waveguide geometries that are not rectilinear may be produced with the aid of the method described above.

The laser beam 4 used for removing material of the optical crystal 2 may also be used to produce periodic poling, or a periodic poling structure, in the optical crystal 2. Periodic poling is intended to mean a periodic inversion of the orientation of the (nonlinear) polarization of the (nonlinear) optical crystal 2, so that regions or domains with opposite polarization are formed. Such a periodic poling structure with a period length of less than, for example, 50 μm may be produced in the optical crystal 2 by moving the laser beam 4 and the optical crystal relative to one another, in the region of the waveguide structure(s) 8a-c. The movement is preferably carried out along one or more paths along which the laser beam 4 travels over the optical crystal 2 in order to produce the periodic poling structure.

A periodic poling structure may also be produced in the optical crystal 2 when the optical crystal 2 is exposed, or irradiated, through a phase mask with the laser beam 4 used for removing material, the exposure usually taking place in the region of the waveguide structures 8a-c. When using a phase mask, periodic poling structures with smaller period lengths, for example with period lengths of less than 10 μm, may be produced.

It is to be understood that the waveguide structures 8a-c may also be produced in the manner described above in optical crystals 2 other than in lithium niobate, for example in LiTa, KTP, etc. These and other optical crystals 2 may already have a refractive index structure, which is used for planar waveguiding, before the processing, for example in the form of PELN. Optical crystals 2 pretreated in other ways may also be processed by means of the method described above in order to produce microstructures, or waveguide structures.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for producing at least one waveguide structure on an optical crystal, the method comprising:
irradiating a pulsed laser beam onto a surface of the optical crystal,
moving the pulsed laser beam and the optical crystal relative to one another along a feed direction in order to remove material of the optical crystal along at least one ablation path in order to form the waveguide structure,
wherein
the pulsed laser beam is irradiated onto the surface of the optical crystal with pulse durations of less than 5 ps and with a wavelength (λ_{L}) of less than 570 nm.

2. The method according to claim 1, wherein a beam axis of the laser beam is tilted at an angle relative to a normal direction of the surface of the optical crystal during the movement of the laser beam and of the optical crystal relative to one another, the angle lying in a plane perpendicular to the feed direction.

3. The method according to claim 2, wherein the angle lies between 2° and 60°.

4. The method according to claim 2, wherein an angle at which the laser beam emerges from a laser processing head is set for the tilting of the beam axis of the laser beam, and wherein the movement of the laser beam and of the optical crystal relative to one another comprises a displacement of the laser processing head and of the optical crystal relative to one another.

5. The method according to claim 2, wherein an angle at which the laser beam emerges from a laser processing head is set for the tilting of the beam axis of the laser beam, and wherein the movement of the laser beam and of the optical crystal relative to one another is carried out by using a scanner device, the laser beam being focused in the laser processing head onto the optical crystal.

6. The method according to claim 2, wherein an angle at which a platform, on which the optical crystal is mounted, is aligned relative to a horizontal plane is set for the tilting of the beam axis of the laser beam.

7. The method according to claim 2, wherein the laser beam has an elliptical beam profile, the aspect ratio of which is selected so that the laser beam aligned at the angle with respect to the normal direction strikes the surface with a circular beam profile.

8. The method according to claim 1, wherein the laser beam and the optical crystal are moved relative to one another several times along laterally offset ablation paths in order to form a trench in the optical crystal.

9. The method according to claim 1, wherein a first trench and a second trench are formed in the optical crystal, neighbouring side walls of the first trench and of the second trench having a predetermined distance from one another and the side walls forming a ridge waveguide.

10. The method according to claim 9, wherein during the formation of the first and second trenches, at least along ablation paths which extend next to a respective side wall of the ridge waveguide, the beam axis of the laser beam is tilted at an angle relative to a normal direction of the surface of the optical crystal, which angle is inclined away from the respective side wall of the ridge waveguide.

11. The method according to claim 10, wherein the laser beam is focused onto a focal plane, which is located on the upper side of the optical crystal, during the formation of a respective trench.

12. The method according to claim 9, wherein the laser beam and the optical crystal are moved several times along the same ablation path relative to one another on a side wall of the trench, which forms a side wall of the ridge waveguide.

13. The method according to claim 1, wherein the optical crystal is selected from the group consisting of: LiNbO₃, LiTa, KTP.

14. The method according to claim 1, wherein the optical crystal has a refractive index structure configured as a lithium niobate-on-insulator (LNOI) or proton-exchanged lithium niobate (PELN).

15. The method according to claim 1, wherein the pulsed laser beam is produced by a solid-state laser.

16. The method according to claim 1, further comprising:
supplying a fluid to the surface of the optical crystal in order to take away removed material.

17. The method according to claim 1, further comprising:
moving the laser beam used for removing material and the optical crystal relative to one another in the region of the waveguide structure, in order to produce a periodic poling structure with period lengths of less than 50 μm in the optical crystal.

18. The method according to claim 1, further comprising:
exposing the optical crystal through a phase mask with the laser beam used for removing material in the region of the waveguide structure, in order to produce a periodic poling structure with period lengths of less than 10 μm in the optical crystal.

19. The method according to claim 1, wherein the pulsed laser beam is irradiated onto the surface of the optical crystal with pulse durations of less than 850 fs and/or with a wavelength (λ_{L}) of less than 380 nm.

20. The method according to claim 5, wherein the laser beam is focused in the laser processing head by using telecentric flat field optics.
